(19) United States
(12) Patent Application Publication
(10) Pub. No.: US 2006/0263030 A1
(43) Pub. Date: Nov. 23, 2006

(54) Multi-purpose communication device with optical mirror

(76) Inventors: Kwang Jin Oh, Fullerton, CA (US); Loren Oh, Fullerton, CA (US)

Correspondence Address: PARK LAW FIRM, 3255 WILSHIRE BLVD, SUITE 1110, LOS ANGELES, CA, 90010, US

(21) Appl. No.: 11/131,723

(22) Filed: May 18, 2005

(51) Int. Cl. G02B 6/00

(52) U.S. Cl. 385/147

(57) ABSTRACT

A multi-purpose communication device with optical mirror includes a communication unit and an optical reflecting device. The communication unit has a case, an antenna, a circuitry, a portable power supply, and a display. The optical reflecting device is installed on the case, and the optical reflecting device partially covers the case of communication device. The communication device includes a cellular phone and the optical reflecting device reflects electromagnetic wave. The optical reflecting device includes a mirror. The optical reflecting device includes a reflecting coating, and a surface is adapted to be fixed to the case of the communication unit, preferably a sticky layer. The multi-purpose communication device includes an anti-scratching device. The anti-scratching device includes one or more propping bumps installed on a surface of the optical reflecting device or on the case. The optical reflecting device may be disposed on the detachable lid of the case.

### BACKGROUND OF THE INVENTION

The present invention relates to a multi-purpose communication device with an optical mirror. More particularly, this invention relates to a multi-purpose communication device in which an optical mirror is attached on the outer surface of the case of the communication device.

It would not be too wild to say that the mobile phone is replacing the fixed phone around the world these days. Since its appearance in 1970s, the mobile phone has kept reducing its size but enlarging its functions. Nowadays, a cutting-edge cellular phones weigh a few ounces only and are fitted in a palm.

If it was a watch that every grownup carried in 1960s, now it is definitely a cellular phone that almost every person including many children carries everywhere all the time in this beginning of 21^{st} century. It seems to be a second body part to people which is sticking around for 24 hours a day.

In the developed countries, the watch industry suffers just because of the digital clock built in the cellular phone.

A mirror is an old example of such a thing while the cellular phone is a brand-new example. In particular, the ladies carry a mirror in their handbag or purse.

It would be a lot of saving of space and trouble if the two items be combined into one.

Accordingly, a need for a multi-purpose communication device has been present. This invention is directed to solve these problems and satisfy the long-felt need.

### SUMMARY OF THE INVENTION

An objective of the invention is to provide a multi-purpose communication device with an optical mirror.

Another objective of the invention is to provide a multi-purpose communication device with an optical mirror, in which the optical mirror is installed on the surface of the communication device lest the mirror surface is scratched.

Still another objective of the invention is to provide a multi-purpose communication device with an optical mirror, in which the mirror is installed on the detachable lid for the portable power supply.

A multi-purpose communication device with optical mirror includes a communication unit and an optical reflecting device. The communication unit has a case, an antenna, a circuitry, a portable power supply, and a display. The optical reflecting device is installed on the case of the communication device, and partially covers the case of communication device.

The communication device includes a mobile phone, preferably a cellular phone.

The optical reflecting device reflects electromagnetic wave, preferably visible lights. The optical reflecting device includes a regular mirror.

The optical reflecting device includes a first surface, a second surface, and a side edge connecting the first surface and the second surface. The first surface is exposed externally when installed on the case of the communication unit. A reflecting coating is provided on the second surface of the optical reflecting device. The second surface is adapted to be fixed to the case of the communication unit.

Alternatively, a reflecting coating is provided on the first surface of the optical reflecting device, and the second surface is adapted to be fixed to the case of the communication unit. A sticky layer is provided on the second surface in an embodiment.

The multi-purpose communication device may further include an anti-scratching device. The anti-scratching device is provided on the first surface of the optical reflecting device. The anti-scratching device includes one or more propping bumps. The propping bump is about a half (½) to two (2) millimeters high. The propping bumps are disposed along the edge of the first surface of the optical reflecting device. Alternatively, the propping bumps are disposed along the edge of the optical reflecting device on a portion of the case of the communication unit which surrounds the optical reflecting device.

The optical reflecting device includes a mirror with a shape of rectangle, and the propping bumps are disposed at the four corners of the first surface of the mirror.

Alternatively, the anti-scratching device includes an anti-scratching coating, which is applied on the first surface of the optical reflecting surface.

The case of the communication unit includes a detachable lid, covering the portable power supply, on the back side of the cellular phone. Alternatively the optical reflecting device is disposed on the detachable lid of the case. In a still another embodiment, the optical reflecting device is integrated with the detachable lid covering the portable power supply.

The advantages of the present invention are: (1) the multi-purpose communication device with optical mirror is convenient to carry and use handy; (2) the optical mirror is protected from scratching by the anti-scratching device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front elevation view of a multi-purpose communication device according to the present invention;

FIG. 2 is a rear elevation view of the communication unit;

FIG. 3 is a rear elevation view of the multi-purpose communication device;

FIG. 4 is a cross-section view of the optical reflecting device installed on the detachable lid for portable power supply in an embodiment;

FIG. 5 is a cross-section view of the optical reflecting device installed on the detachable lid for portable power supply in another embodiment;

FIG. 6 is a cross-section view of the optical reflecting device installed on the case in still another embodiment;

FIG. 7 is a cross-section view of the optical reflecting device in an embodiment, and

FIG. 8 is a cross-section view of the optical reflecting device in another embodiment.

### DETAILED DESCRIPTION OF THE INVENTION

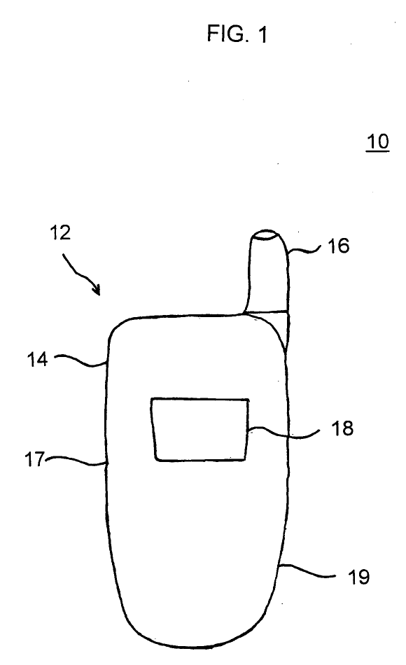

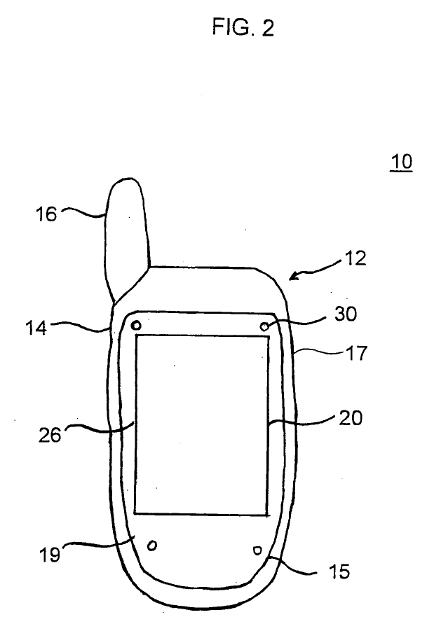

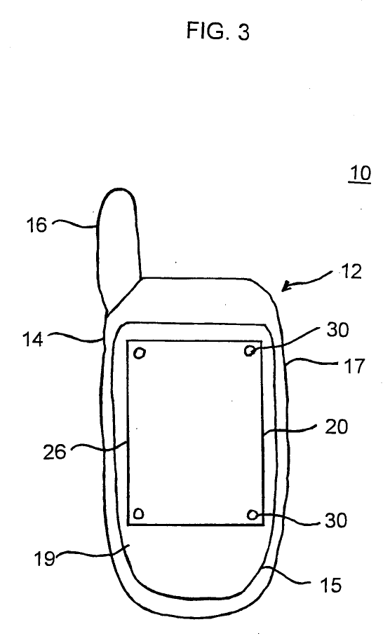

FIG. 1 and FIG. 3 show the front and rear elevation views of a multi-purpose communication device 10 according to the present invention. FIG. 2 shows the rear elevation view of the communication unit 12 only.

The multi-purpose communication device 10 with optical mirror includes a communication unit 12 and an optical reflecting device 20. The communication unit 12 has a case 14, an antenna 16, a circuitry 17, a portable power supply 19, and a display 18. The optical reflecting device 20 is installed on the case 14 of the communication device 10, and partially covers the case 14 of communication device 10.

The communication unit 12 includes a mobile phone, preferably a cellular phone.

The optical reflecting device 20 reflects electromagnetic wave, preferably visible lights. The optical reflecting device 20 includes a regular mirror 26.

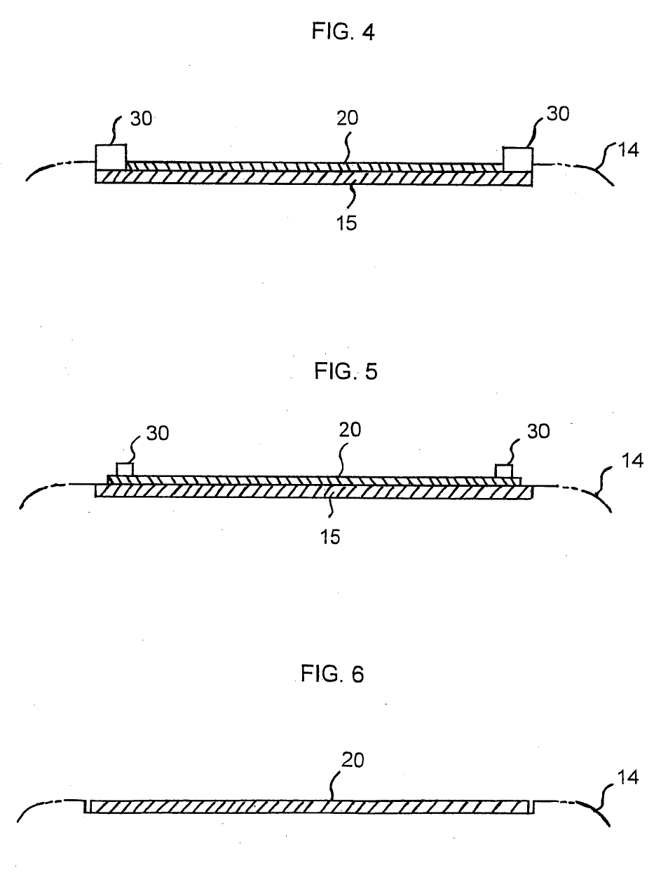

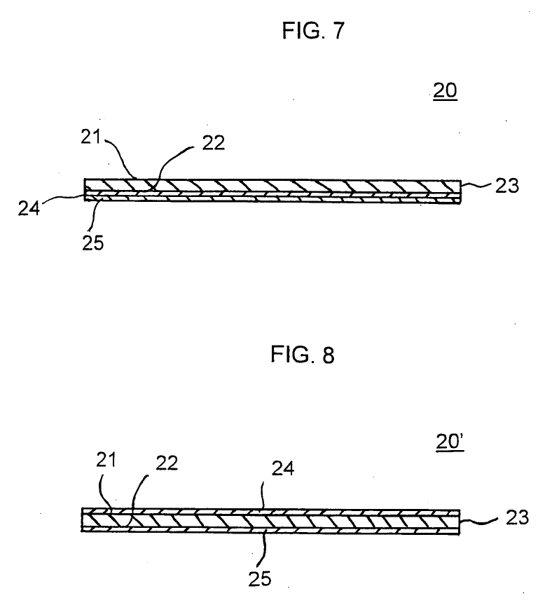

As shown in FIGS. 4 through 8, the optical reflecting device 20 includes a first surface 21, a second surface 22, and a side edge 23 connecting the first surface 21 and the second surface 22. The first surface 21 is exposed externally when installed on the case 14 of the communication unit 12. A reflecting coating 24 is provided on the second surface 22 of the optical reflecting device 20. The second surface 22 is adapted to be fixed to the case 14 of the communication unit 12 as shown in FIG. 7.

The reflecting coating 24 is provided on the first surface 21 of the optical reflecting device 20, and a sticky layer 25 is provided on the second surface 22 in an embodiment as shown in FIG. 8.

The multi-purpose communication device 10 may further include an anti-scratching device 30. The anti-scratching device 30 is provided on the first surface 21 of the optical reflecting device 20. The anti-scratching device 30 includes one or more propping bumps. The propping bump 30 is about a half (½) to two (2) millimeters high. The propping bumps 30 are disposed along the perimeter of the first surface 21 of the optical reflecting device 20. Alternatively, the propping bumps 30 are disposed along the perimeter of the optical reflecting device 20 on a portion of the case 14 of the communication unit 12 which surrounds the optical reflecting device 20.

The optical reflecting device 20 includes a mirror 26 with a shape of rectangle, and the propping bumps 30 are disposed at the four corners of the first surface 21 of the optical reflecting device 20 as shown in FIG. 3.

The anti-scratching device 30 includes an anti-scratching coating, which is applied on the first surface 21 of the optical reflecting surface 20.

The case 14 of the communication unit 12 includes a detachable lid 15, covering the portable power supply 19, on the back side of the communication device 10. The optical reflecting device 20 is disposed on the detachable lid 15 of the case 14.

The optical reflecting device 20 may be made of metal, plastic, or glass.

In a still another embodiment, the optical reflecting device 20 can be slidably and detachably fit into a groove right on the case 14 as shown in FIG. 6.

In a still another embodiment, the optical reflecting device 20 is integrated with the detachable lid 15 covering the portable power supply 19.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A multi-purpose communication device with optical mirror comprising:
a) a communication unit having a case, an antenna, a circuitry, a portable power supply, and a display; and
b) an optical reflecting device,
wherein the optical reflecting device is installed on the case of the communication device, wherein the optical reflecting device partially covers the case of communication device.

2. The multi-purpose communication device of claim 1, wherein the communication device comprises a cellular phone.

3. The multi-purpose communication device of claim 1, wherein the optical reflecting device reflects electromagnetic wave.

4. The multi-purpose communication device of claim 3, wherein the optical reflecting device comprises a mirror.

5. The multi-purpose communication device of claim 3, wherein the optical reflecting device reflects visible light.

6. The multi-purpose communication device of claim 1, wherein the optical reflecting device comprises a first surface, a second surface, and a side edge connecting the first surface and the second surface, wherein the first surface exposes when installed on the case of the communication unit.

7. The multi-purpose communication device of claim 6, wherein a reflecting coating is provided on the second surface of the optical reflecting device.

8. The multi-purpose communication device of claim 7, wherein the second surface is adapted to be fixed to the case of the communication unit.

9. The multi-purpose communication device of claim 6, wherein a reflecting coating is provided on the first surface of the optical reflecting device, wherein the second surface is adapted to be fixed to the case of the communication unit.

10. The multi-purpose communication device of claim 9, wherein a sticky layer is provided on the second surface.

11. The multi-purpose communication device of claim 6, further comprising an anti-scratching device.

12. The multi-purpose communication device of claim 11, wherein the anti-scratching device is provided on the first surface of the optical reflecting device.

13. The multi-purpose communication device of claim 11, wherein the anti-scratching device comprises one or more propping bumps.

14. The multi-purpose communication device of claim 13, wherein the propping bump is about a half (½) to two (2) millimeters high.

15. The multi-purpose communication device of claim 14, wherein the propping bumps are disposed along the edge of the first surface of the optical reflecting device.

16. The multi-purpose communication device of claim 14, wherein the propping bumps are disposed along the edge of the optical reflecting device on a portion of the case of the communication unit which surrounds the optical reflecting device.

17. The multi-purpose communication device of claim 16, wherein the optical reflecting device comprises a mirror, wherein the mirror has a shape of rectangle, wherein the propping bumps are disposed at the four corners of the first surface of the mirror.

18. The multi-purpose communication device of claim 11, wherein the anti-scratching device comprises an anti-scratching coating, wherein the anti-scratching coating is applied on the first surface of the optical reflecting surface.

19. The multi-purpose communication device of claim 1, wherein the case of the communication unit comprises a detachable lid, covering the portable power supply, on the back side of the cellular phone.

20. The multi-purpose communication device of claim 19, wherein the optical reflecting device is disposed on the detachable lid of the case.

21. The multi-purpose communication device of claim 19, wherein the optical reflecting device is integrated with the detachable lid covering the portable power supply.
